(19) United States
(12) Patent Application Publication
(10) Pub. No.: US 2006/0021520 A1
(43) Pub. Date: Feb. 2, 2006

(54) FEEDER STRUCTURE FOR JUICER

(76) Inventor: Maxwell Hsu, Tao-Yuan (TW)

Correspondence Address: Yi-Wen Tseng, 4331 Stevens Battle Lane, Fairfax, VA, 22033, US

(21) Appl. No.: 10/900,085

(22) Filed: Jul. 28, 2004

(51) Int. Cl. A23N 1/00

(52) U.S. Cl. 99/511

(57) ABSTRACT

A feeder structure for a juicer. The juicer includes an upper machine body, a lower machine body, a strainer, an extraction plate, and a cover body. The lower machine body has an electric motor installed inside which has a rotational axis extending from the center thereof. The strainer and the extraction plate are installed into the upper machine body with their center being sleeved and secured onto the rotational axis of the electric motor. The cover body has a feeder into which at least one orienting element is installed. The orienting element protrudes from the inner wall of the feeder and forms a stop portion. The cover body is sleeved over the upper machine body with the lower end of the feeder extending into the interior of the strainer. By utilizing the orienting element of the feeder, various vegetables or fruits with different dimensions and shapes will not rotate together with the extraction plate, and thereby are capable of being cut apart by the extraction plate. The present invention enhances the convenience and simplicity of a juicer.

### BACKGROUND OF THE INVENTION

The present invention relates in general to a feeder structure for a juicer, and more particularly, to a feeder installed into a cover body of a juicer, which is suitable for various vegetables and fruits with different dimensions and shapes, and therefore, enhances the convenience and simplicity of a juicer.

A conventional feeder of a juicer is disclosed in Taiwan utility patent publication No. 493417. In this example the feeder is located at the center of the top of the juicer and has a cylinder like shape with a chamfer formed at one side thereof. Vegetables and fruits inserted into the feeder are stopped by the said chamfer and further cut apart by the extraction blades of the extraction plate.

However, the conventional feeder structure has at least three drawbacks. The first drawback is that because the inlet of the feeder is not an exact circle, the inlet does not fit the natural contours of different fruits and vegetables. The dimensions and shapes of the vegetables or fruits suitable for being put into the feeder are limited. The second drawback is that it is difficult for a conventional juicer to extract juice from vegetables or fruits with an elongated and slim shape. Because the diameter of a slim vegetable or fruit is much smaller than that of the feeder, the chamfer of the feeder loses its blocking effect. The slim vegetable or fruit rotates within the feeder when being driven by the extraction circle plate. The third drawback is the unwanted waste of the vegetable or fruit which is caused by the large gap between the bottom of the feeder and the top of the extraction circle plate. When the vegetable or fruit has been cut into a size smaller than this gap, the vegetable or fruit will not be blocked by the chamfer and will instead start to rotate together with the extraction circle plate. It is inconvenient for extracting operation, and wastes a lot of raw materials.

### BRIEF SUMMARY OF THE INVENTION

The present invention provides a feeder structure for a juicer. The vegetables or fruits put into the feeder are stopped and oriented inside the feeder by an orienting element of the feeder. By utilizing the orienting element of the feeder, various vegetables or fruits with different dimensions and shapes will not rotate together with the extraction plate. The slim vegetable or fruit is thereby capable of being cut apart by the extraction plate. The present invention is suitable for various vegetables and fruits with different dimensions and shapes, and therefore, enhances the convenience and simplicity of a juicer.

Accordingly, the juicer includes an upper machine body, a lower machine body, a strainer, an extraction plate, and a cover body. The lower machine body has an electric motor installed inside which has a rotational axis extending from the center thereof. The strainer and the extraction plate are installed into the upper machine body with their center being sleeved and secured onto the rotational axis of the electric motor. The cover body has a feeder into which at least one orienting element is installed. The orienting element protrudes from the inner wall of the feeder and forms a stop portion. The cover body is sleeved over the upper machine body with the lower end of the feeder extending into the interior of the strainer.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

These as well as other features of the present invention will become more apparent upon reference to the drawings therein:

FIG. 1 is a perspective view of a juicer with a feeder in accordance with the present invention.

FIG. 2 is a partial cross-sectional view of a juicer with a feeder in accordance with the first embodiment of the present invention.

FIG. 3 is a top view of a juicer with a feeder in accordance with the first embodiment of the present invention.

FIG. 4 is a partial cross-sectional view of a juicer with a feeder in accordance with the present invention, illustrating the usage of the present invention.

FIG. 5 is a top view of a juicer with a feeder in accordance with the present invention, illustrating the usage of the present invention.

FIG. 6 is a partial cross-sectional view of a juicer with a feeder in accordance with the second embodiment of the present invention.

FIG. 7 is a partial cross-sectional view of a juicer with a feeder in accordance with the third embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers are used in the drawings and the description to refer to the same or like parts.

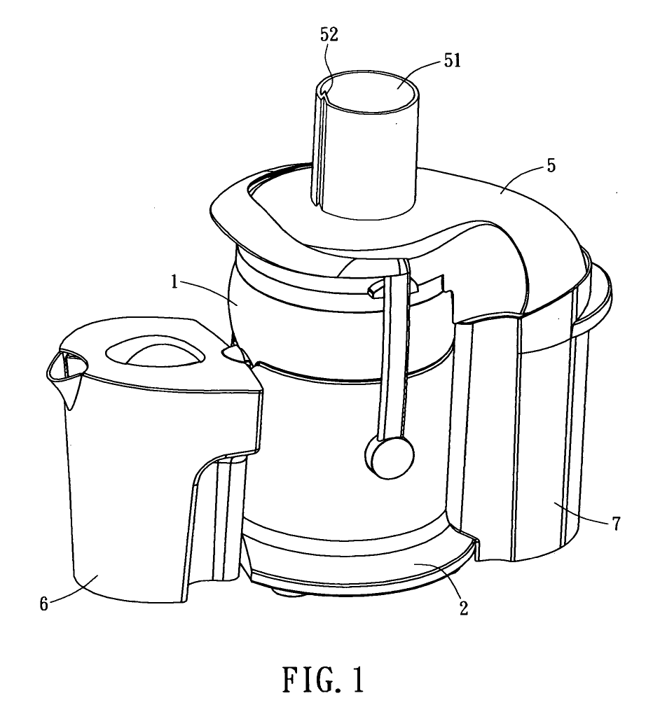

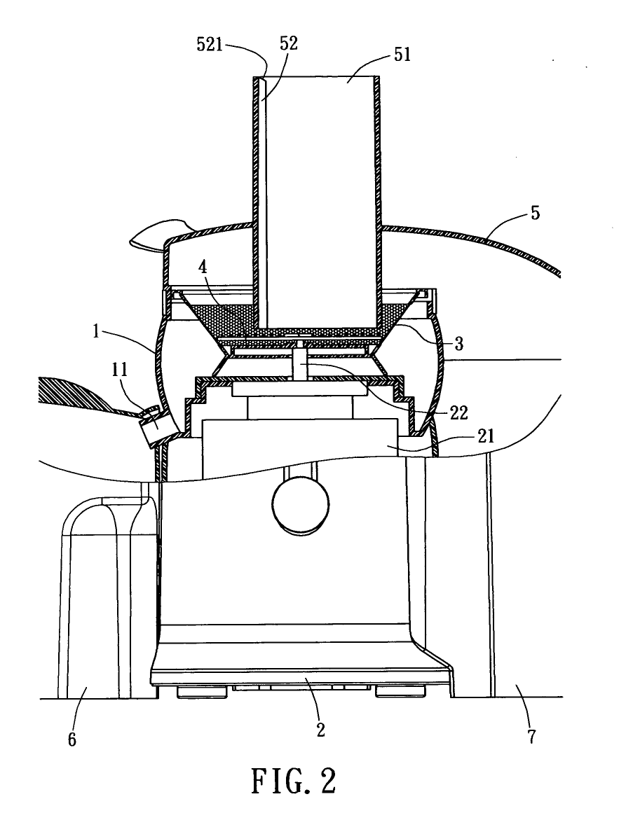

Referring to FIG. 1 through FIG. 3, a juicer of the present invention includes an upper machine body 1, a lower machine body 2, a strainer 3, an extraction plate 4, a cover body 5, a juice cup 6, and a pulp bin 7. The lower machine body 2 has an electric motor 21 installed inside. The electric motor 21 has a rotational axis 22 extending from the center thereof toward the interior of the upper machine body 1. The upper machine body 1 has the strainer 3 and the extraction plate 4 installed inside. The extraction plate 4 is installed onto the inner bottom surface of the strainer 3. The strainer 3 and the extraction plate 4 are sleeved and secured onto the rotational axis 22 of the electric motor 21. Further, the upper machine body 1 has a juice outlet 11 formed adjacent to the top of the lower machine body 2.

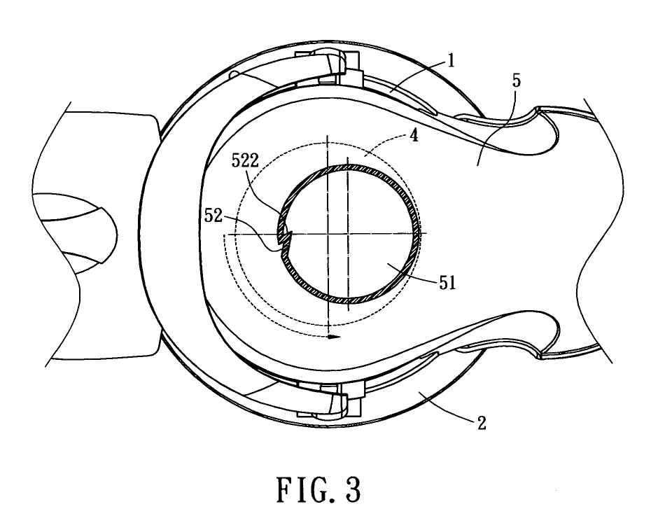

The cover body 5 with a feeder 51 is sleeved over the upper machine body 1. The bottom of the feeder 51 extends into the interior of the strainer 3. The diameter of the feeder 51 is much smaller than that of the extraction plate 4. The center of the feeder 51 may align with the center of the extraction plate 4, or deviate from the center of the extraction plate 4. Any such deviation may be based on a single axis or may be planar, being based on two axes. In the embodiment illustrated, the center of the feeder 51 deviates from the center of the extraction plate 4 with single axial displacement. An orienting element 52 is installed onto the inner wall of the feeder 51. The direction of the orienting element 52's extension is parallel with the axial center line of the feeder 51. The orienting element 52 can be either integrally formed with or assembled onto the feeder 51. In the present embodiment, the orienting element 52 is integrally formed with the feeder 51 by recessing a portion of the exterior wall of the feeder 51 to form a protruding portion in the interior of the feeder 51. On the top of the orienting element 52 a slope edge 521 descends from the top of the feeder 51 toward the interior of the feeder 51. This slope edge 521 is provided to facilitate the receiving and orienting of the vegetables or fruits which are put into the feeder 51. The orienting element 52 has a stop portion 522 which may be parallel with or has a slope angle with the radial line. In the present embodiment, the stop portion 522 has a slope angle with the radial line, the slope angle opposes the extraction plate 4's direction of rotation, as illustrated in FIG. 3.

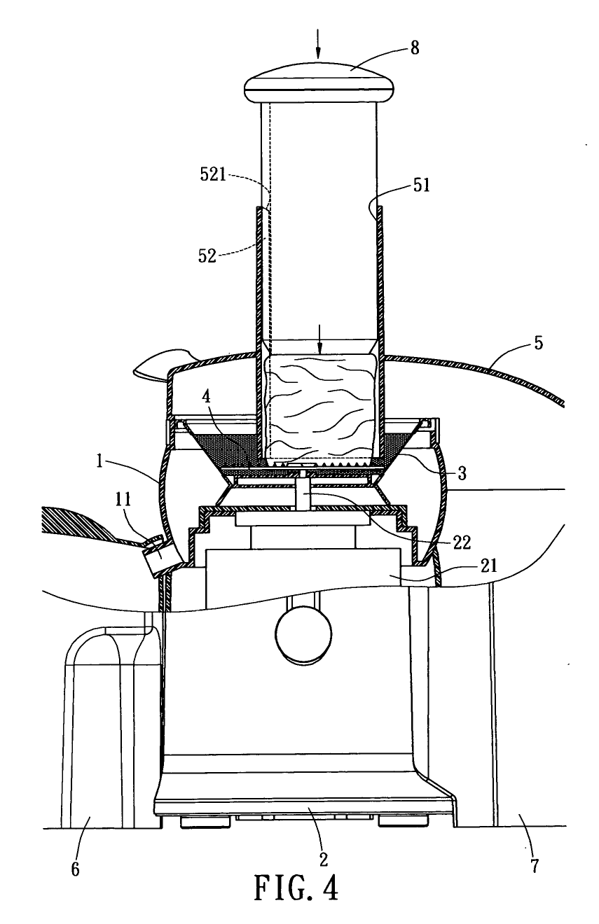

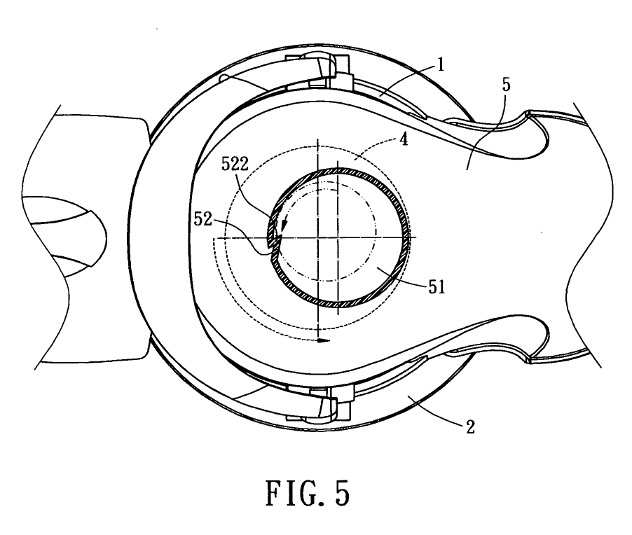

Referring to FIG. 4 and FIG. 5, a cross-sectional view and a front view illustrating the usage of a feeder in accordance with the present invention are shown. Vegetables or fruits with different sizes or shapes are put into the feeder 51, and further pressed against the extraction plate 4 by a plunger 8. The vegetables or fruits are thereby reduced into juices and pulps. The juice flows from the meshes of the strainer 3 and further down through the outlet 11 into the juice cup 6, while centrifugal force moves the pulp upward along the slope plane of the strainer 3 before falling into the pulp bin 7. When the shapes of the vegetables or fruits put into the feeder 51 are elongated and slim, because the center of the feeder 51 deviates from the center of the extraction plate 4 with single axial displacement, the vegetables or fruits under the centrifugal force will move toward the interior circumference of the feeder 51, and therefore, be stopped and oriented inside the feeder 51 by the stop portion 522 of the orienting element 52. The slim vegetable or fruit is thereby capable of being cut apart by the extraction plate 4.

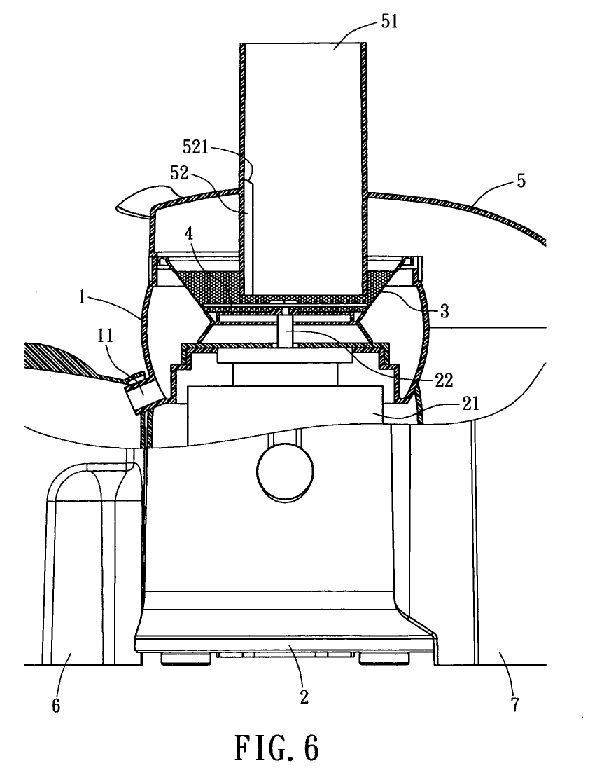

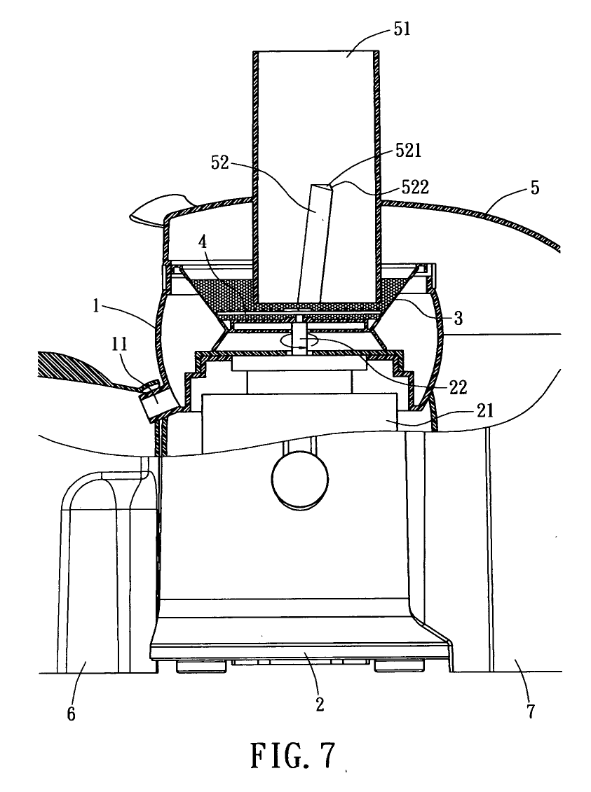

Referring to FIG. 6 and FIG. 7, cross-sectional views of the second and the third embodiment of the present invention are shown respectively. In the second embodiment, the length of the orienting element 52 is much smaller than the axial length of the feeder 51 so that the vegetables or fruits can be easily stored into the feeder 51 and further wedged and oriented by the orienting element 52, as illustrated in FIG. 6. In the third embodiment, the extending direction of the orienting element 52 is not parallel with the axial center line, it a slope angle with the axial center line. The tilted direction of the orienting element 52 accords with the rotating direction of the extraction plate 4, as illustrated in FIG. 7.

The feeder structure in accordance with the present invention has at least three benefits. The first benefit is that by utilizing the orienting element of the feeder, various vegetables or fruits with different dimensions and shapes will not rotate together with the extraction plate. The present invention is suitable for different vegetables and fruits, and therefore, enhances the convenience and simplicity of a juicer. The second benefit is that because the center of the feeder deviates from the center of the extraction plate with single axial displacement, the vegetables or fruits under the centrifugal force will move toward the interior circumference of the feeder. This center deviation facilitates the orienting element's orienting function and the extraction plate's extracting operation. The third benefit is that the extending direction of the orienting element has a slope angle with the axial center line. The tilted direction of the orienting element accords with the rotating direction of the extraction plate. Thereby, a consumer does not need to apply as much force in order to extract the juice from the vegetables or fruits.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

What is claimed is:

1. A juicer comprising:
an upper machine body;
a lower machine body having an electric motor installed inside, the electric motor having a rotational axis extending from the center thereof toward the interior of the upper machine body;
a strainer and an extraction plate installed inside the upper machine body, being sleeved and secured onto the rotational axis; and
a cover body having a feeder extending into the interior of the strainer, the feeder having at least one orienting element installed onto the inner wall thereof, and the orienting element protruding from the inner wall of the feeder and forming a stop portion.

2. The feeder structure of claim 1, wherein the feeder and the orienting element are integrally formed.

3. The feeder structure of claim 1, wherein the feeder is cylindrical in configuration.

4. The feeder structure of claim 1, wherein an inner diameter of the feeder is smaller than a diameter of the extraction plate.

5. The feeder structure of claim 1, wherein the center of the feeder is aligned with the center of the extraction plate.

6. The feeder structure of claim 1, wherein the center of the feeder deviates from the center of the extraction plate with either a single axial displacement or a dual axial displacement.

7. The feeder structure of claim 1, wherein a length of the orienting element equals to an axial length of the feeder.

8. The feeder structure of claim 1, wherein a slope edge descending from the top of the feeder toward the interior of the feeder is formed on the top of the orienting element.

9. The feeder structure of claim 1, wherein the length of the orienting element is smaller than the axial length of the feeder.

10. The feeder structure of claim 1, wherein the stop portion of the feeder has a slope angle with a radial line of the feeder.

11. The feeder structure of claim 1, wherein the stop portion of the feeder is parallel with a radial line of the feeder.

12. The feeder structure of claim 1, wherein the stop portion of the feeder has a slope angle with an axial center line of the feeder.
